(19) United States
(12) Patent Application Publication
(10) Pub. No.: US 2014/0095887 A1
(43) Pub. Date: Apr. 3, 2014

(54) METHOD AND APPARATUS FOR MAINTAINING TRUSTED TIME AT A CLIENT COMPUTING DEVICE

(71) Applicants: Alex NAYSHTUT, Gan Yavne (IL); Omer BEN-SHALOM, Rishon Le-Tzion (IL); Abdul BAILEY, Tigard, OR (US); Adi SHALIV, Nir-Banim (IL)

(72) Inventors: Alex NAYSHTUT, Gan Yavne (IL); Omer BEN-SHALOM, Rishon Le-Tzion (IL); Abdul BAILEY, Tigard, OR (US); Adi SHALIV, Nir-Banim (IL)

(21) Appl. No.: 13/631,908

(22) Filed: Sep. 29, 2012

(51) Int. Cl. G06F 1/04; G06F 12/14

(52) U.S. Cl. 713/189; 713/600

(57) ABSTRACT

In accordance with disclosed embodiments, there are provided methods, systems, and apparatuses for maintaining trusted time at a client computing device including, for example, executing a computer program within a client device; initiating a call from the computer program to a secure time service of the client device requesting a trusted time stamp; retrieving, via the secure time service of the client device, a protected time from protected clock hardware of the client device; generating, at the secure time service of the client device, the trusted time stamp by signing the protected time retrieved from the protected clock hardware of the client device; and returning the trusted time stamp to the computer program. Other related embodiments are disclosed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the field of computing, and more particularly, to methods and apparatuses for maintaining trusted time at a client computing device.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed subject matter.

Within a computing environment, there are various services, software, and other mechanisms which for one reason or another, must rely upon time stamping. For instance, an entry within a digital log may be time stamped, and the entry along with its time stamp may be of value to a network or system administrator when diagnosing a problem, especially issues which pertain to security such as incident handling. Certain software and licenses rely upon time stamping, such as “trialware” software which may be utilized for free for a specified period of time, after which, use of the software must cease or a paid license must be obtained. Some digital content likewise relies upon time stamping. For instance, certain content, such as eBooks, music, movies or video, and so forth, may be downloadable to a local client system for consumption within a specified period of time. The mechanism controlling access to such content will then terminate access to the content after the pre-determined time period.

The problem with each of the above examples is that conventional time stamping mechanisms for a local computing client are inherently unreliable because they are directly accessible to an end user and software running in the operating system and further because they are subject to manipulation by the end user or such software.

In each of the above examples, the true “time” is subject to manipulation and abuse, thus rendering the mechanisms for determining, for example, the true time of a log entry, the validity of a trialware software application, or the continued access to digital content, at least partially ineffective.

Other software applications provide a time stamp merely as metadata or “information” about associated data, such as email clients that tag an outgoing email with the local system's time stamp at the “time” the email is sent or a widget that displays to a user the current “time” according to the system's own clock. While such time stamps are typically informational only, they are nevertheless potentially unreliable and subject to manipulation and abuse. For instance, a system having an erroneous system time for whatever reason, may allow a user to send an email tagged with an incorrect time stamp which in turn will be displayed at a recipient's email client. Additionally, the same user having an incorrect system time may have a widget at a user interface which displays the incorrect time to the user. Such lack of reliable time stamping also hinders the reliability of mechanisms related to e-discovery.

The present state of the art may therefore benefit from the methods and apparatuses for maintaining trusted time at a client computing device as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 illustrates an exemplary architecture in accordance with which embodiments may operate;

FIGS. 2A, 2B, and 2C set forth flow diagrams illustrating methods for maintaining trusted time at a client computing device in accordance with described embodiments;

FIG. 3A illustrates an alternative exemplary architecture in accordance with which embodiments may operate;

FIG. 3B is a flow diagram illustrating a method for maintaining trusted time at a client computing device in accordance with described embodiments;

FIG. 4A depicts a tablet computing device and a hand-held smartphone each having a circuitry, components, and functionality integrated therein as described in accordance with the embodiments;

FIG. 4B is a block diagram of an embodiment of tablet computing device, a smart phone, or other mobile device in which touchscreen interface connectors are used; and

FIG. 5 illustrates a diagrammatic representation of a machine in the exemplary form of a computer system, in accordance with one embodiment.

### DETAILED DESCRIPTION

Described herein are systems, apparatuses, and methods for maintaining trusted time at a client computing device. For example, in one embodiment, such means may include means for executing a computer program within a client device; means for initiating a call from the computer program to a secure time service of the client device requesting a trusted time stamp; means for retrieving, via the secure time service of the client device, a protected time from protected clock hardware of the client device; means for generating, at the secure time service of the client device, the trusted time stamp by signing the protected time retrieved from the protected clock hardware of the client device; and means for returning the trusted time stamp to the computer program.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled with a computer system bus. The term “coupled” may refer to two or more elements which are in direct contact (physically, electrically, magnetically, optically, etc.) or to two or more elements that are not in direct contact with each other, but still cooperate and/or interact with each other.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

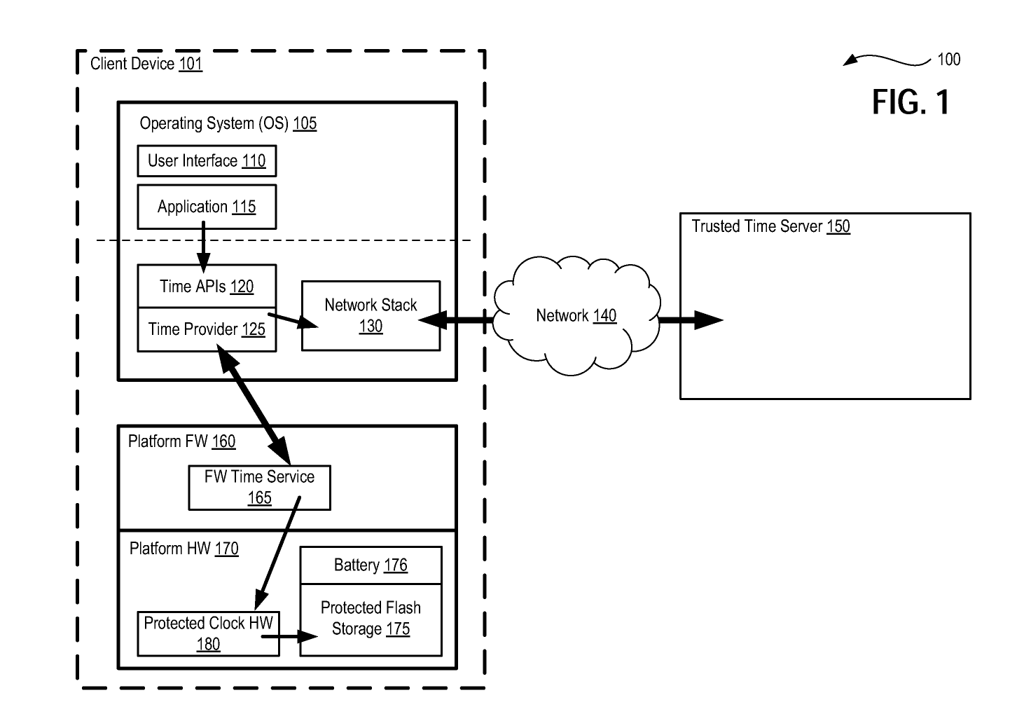

FIG. 1 illustrates an exemplary architecture 100 in accordance with which embodiments may operate. In particular, depicted within an exemplary client device 101 is an Operating System (OS) 105 and platform Firmware (FW) 160. Connected to the client device 101 via network stack 130 through network 140 is a trusted time server 150.

At the client device 101 within the operating system 105 is a user interface 110 and an application 115, both of which are directly accessible and controllable by a user on the top portion of the depicted operating system 105. At the bottom portion of the exemplary operating system 105 are time APIs (Application Programming Interfaces) 120 which is accessible to the application 115 but is not directly accessible to the user through the user interface 110. Further depicted is network stack 130 accessible to software and APIs of the client device 101 including the time APIs 120.

Time APIs 120 are interfaced to a time provider 125 agent or service within the operating system 105 which is communicatively interfaced to a platform firmware (FW) 160 layer of the client device 101. More particularly, the time provider 125 is communicatively interfaced to a firmware time service 165 within the platform firmware 160 which in turn is connected to protected clock hardware (HW) 180 within the platform hardware 170 of the client device 101. The firmware time service 165 is also referred to as a secure time service within the platform firmware 160. The protected clock hardware 180 is capable of accessing protected flash storage 175 which maintains a clock through power cycles and diverse power state transitions of the client device 101 through the aid of a local battery 176 dedicated exclusively to the protected clock hardware 180. For instance, the protected clock hardware 180 may be implemented as non-volatile memory with a local battery 176 backup or as a CMOS (complementary-metal-oxide-semiconductor) with a local battery 176 backup to maintain a clock without regard to whether the computing device 101 has power for its remaining components or is in an active state or a power off state.

In a conventional system, computing software is able to time stamp system events and anything else originating from within such a system. However, conventional time stamps are not reliable and anything running on the system can alter or remove the time stamps as well as alter or wholly remove the data associated with such time stamps, regardless of how critical the data may be or what other mechanisms may rely upon such data and time stamps.

The depicted architecture 100 enables the client device 101 to provide trusted time stamps which, unlike time stamps from conventional systems, can be relied upon with a high degree of confidence in the time stamp's authenticity by other mechanisms, software, users, administrators, remote devices, and any other entity referencing or relying upon the trusted time stamps.

For example, a network or system administrator making reference to logs having a trusted time stamp associated with or tagged to the log information can rely upon the data with certainty knowing that it was not subjected to abuse, malicious or fraudulent altercation, or merely incorrect due to negligent system maintenance. Such time stamps may be of critical import, for example, to an administrator attempting to determine a precise chronological order of failure systems or events within a system or across multiple nodes, where the true and correct time determinable from a trusted time stamp is critical to a root cause determination.

A system or network administrator may alternatively rely upon a trusted time stamp to investigate an unauthorized intrusion into a network or a system by a hacker or other malicious entity. In a conventional system, such a malicious entity could spoof the time entries in a log in an effort to thwart detection. However, in a client device 101 which associates or tags log entries with a trusted time stamp, such a network administrator can know with certainty that event times reflect the true and correct time, as the trusted time stamp is not subject to manipulation.

Replay attacks are another potential threat where a falsified time stamp for a legitimate event may be resent to a waiting entity which will unwittingly record the falsified time stamp as legitimate. Certificate expirations can likewise be avoided by causing a machine to revert to an older time, after which an expired and illegitimate certificate can be utilized with impunity as the client device will “trust” the seemingly non-expired certificate. Conventional validation schemes use a system's real time clock to evaluate validity which presents a security hole for certificate schemes.

In yet another example, there may be instances upon which a trusted time stamp of a client device 101 could be far more persuasive in a legal setting than an ordinary time stamp. Consider for example, reliance upon documents having metadata showing an origination date and a last accessed or modified date, or email submitted as evidence with an associated time stamp, or a record in a database recorded for compliance with SEC (Securities and Exchange Commission) requirements, such as Sarbanes-Oxley Act provisions. An expert understanding conventional systems can readily testify to the untrustworthy nature of conventional time stamps whereas documents, records, and events associated with a trusted time stamp such as those taught herein may prove far more persuasive and credible as they are not subject to manipulation and abuse.

Other examples exist where conventional systems providing time stamps are simply not reliable or sufficient. If the system from which the time stamp originates cannot be trusted because anyone with access to the system is able to change the system time, then any information associated with or tagged by the system time simply cannot be trusted. It is nevertheless required at times to rely upon a locally originated time stamp, thus presenting a difficult problem to any entity which references or relies upon such information.

Although time may also be maintained or verified by a remote entity, a local system may not necessarily be connected with such a remote entity, and thus, it still cannot be made certain that time stamps of the local system were not altered or manipulated during periods of no connectivity to the remote entity. A trusted time stamp such as that which is described herein would thus be far preferred for those which must rely upon the time information of a system which generates events during such periods of no connectivity to a remote entity. For example, a system will be in a non-connected state during much of the system's boot sequence. This boot sequence may be a very sensitive period because the main executables are loaded onto the system, including the operating system itself. Logging of the events that occur during the system's boot sequence can be very important for the sake of computer forensics, and having accurate and trusted time stamping may be of critical import.

In accordance with certain embodiments, such as that which is depicted at FIG. 1, a clock is embodied as protected clock hardware 180 and maintained by protected flash storage 175 in a platform hardware 170 specifically, and not within either platform firmware 160 or a software layer, such as an operating system 105 of the client device 101. Such an architecture may utilized where the operating system 105 cannot be adequately trusted. In other embodiments, a clock is embodied within the platform firmware 160 and maintained by protected flash storage 175 in the platform hardware 170.

According to one embodiment, the protected flash storage 175 provides a tamper resistant and isolated flash storage which is not directly accessible to the operating system 105 or a user of the client device 101, and thus, is not subject to manipulation.

According to one embodiment, the trusted time server 150 utilizes an externally trusted time source, such as the managing entity of the client device 101 platform or a Domain Controller, or a trusted internet time server, etc. In one embodiment, the protected clock hardware 180 embodies a local hardware protected clock (e.g., local to the client device 101) with platform hardware 170 and/or platform firmware 160 cryptographic capability for signature and time stamping of local events resulting in a trusted time stamp. According to one embodiment, the time provider 125 exposes the secure time stamp capabilities to a host of the client device, such as the depicted software components user interface 110 and/or application 115 of the operating system 105 and further provides exposure of the secure time stamp capabilities through the time APIs at element 120.

With conventional systems, it is impossible for software to receive trusted time stamping for usages such as non-repudiated logging without accessing back-end services over a network 140. However, applications which rely upon network 140 access to provide receive trusted time stamping will predictably fail when the client device 101 is not connected to the network 140 or operating from a location where the traffic to/from a trusted server is simply not available. Therefore, it is in accordance with one embodiment that local and always available capability for secure time stamping is provided to the client device 101 through the network stack 130.

In such a way, a trusted time stamp is nevertheless available to the client device 101 for implementations which require the trusted time stamp regardless of network 140 connectivity. Such implementations may include the use of non-repudiated logging, offline consumption of time limited content, authentication of services while in an offline operational mode, and software trial licenses enforcement. According to one embodiment, the trusted time source is made available as a local loop-back of the client device 101 through the network stack. For instance, the trusted time source can be made available at a known address such as 127.0.0.1:123, in which the local trusted time source can be used by any software running on the platform without any need for code revision or retrofitting to communicate with the provided time APIs 120. Instead, such software can simply be configured to access the trusted time source through the existing network location configuration options which point to the a device's local loop back and when referenced, pulls or retrieves a trusted time stamp from either the time APIs 120 or the time provider 125 through the local loopback network interface.

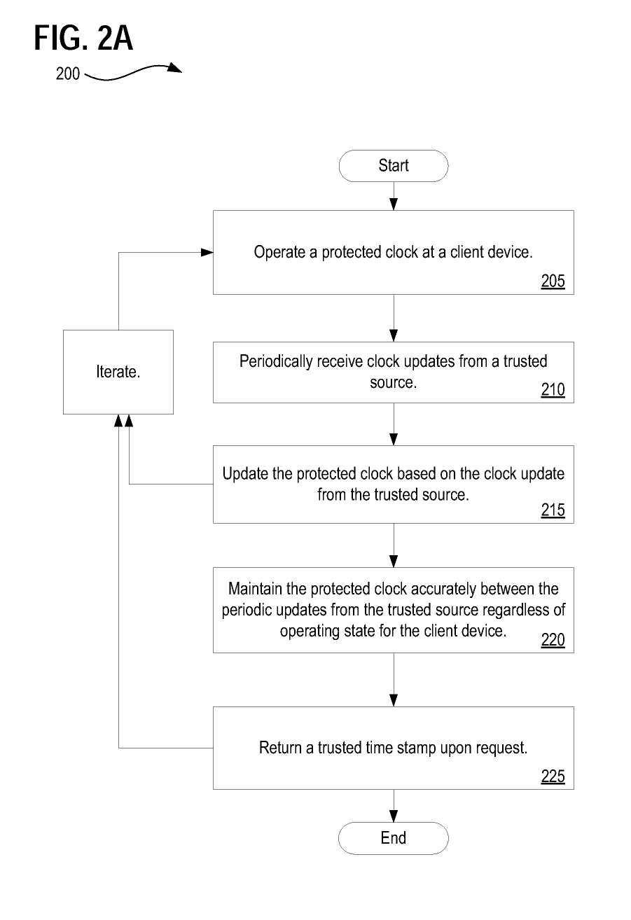

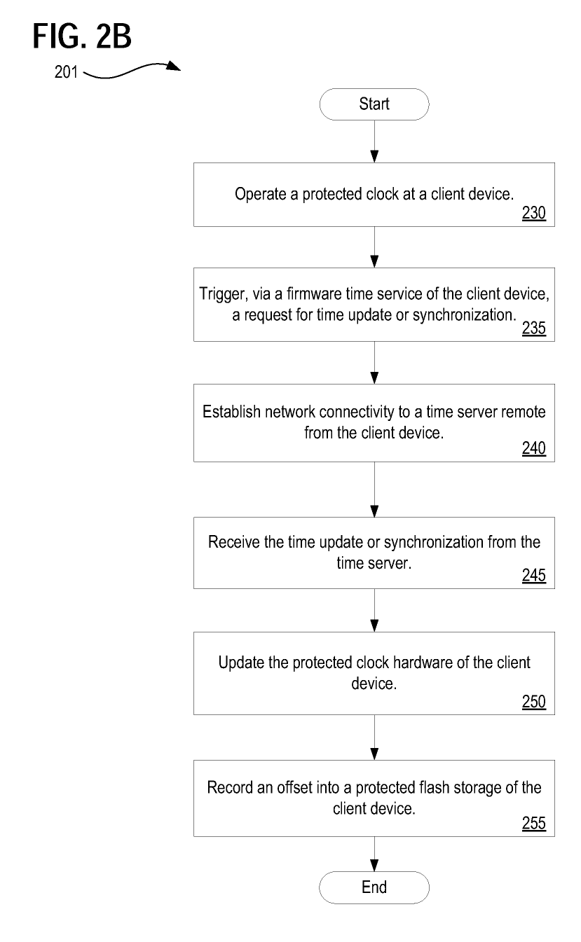

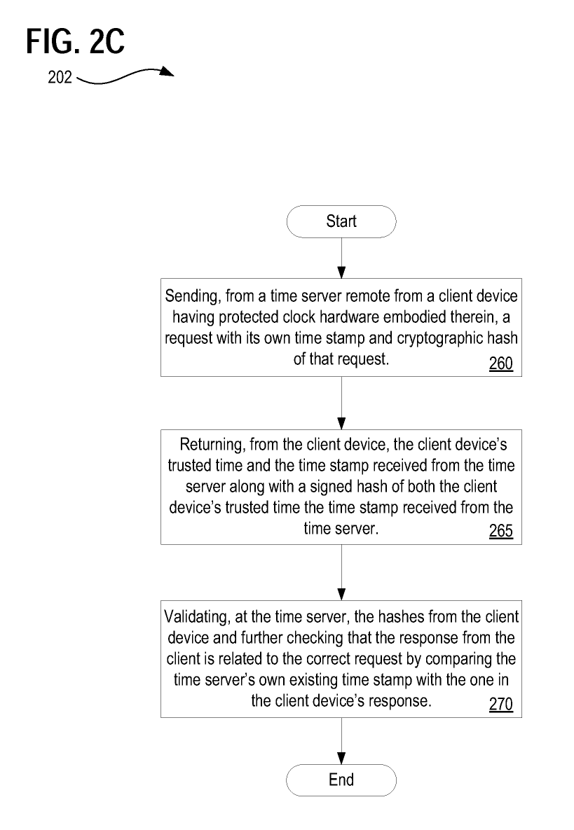

FIGS. 2A, 2B, and 2C set forth flow diagrams illustrating methods 200, 201, and 202 for maintaining trusted time at a client computing device in accordance with described embodiments. Methods 200, 201, and 202 may be performed by processing logic that may include hardware (e.g., circuitry, dedicated logic, programmable logic, microcode, etc.), including that of a client (e.g., client device 101 of FIG. 1) and/or a services provider (e.g., trusted time server 150 of FIG. 1). The numbering of the blocks presented is for the sake of clarity and is not intended to prescribe an order of operations in which the various blocks must occur.

At FIG. 2A, method 200 describes an initialization process utilized by the secure platform based time server, for example, to provision, initialize, or update the trusted time of a client device 101.

Method 200 begins with processing logic for operating a protected clock at a client device (block 205).

At block 210, processing logic periodically receives clock update from a trusted source. For example, the trusted source may be a trusted time server 150 accessible to the client device 101 over a network 140, when the client device 101 is connected with the network 140. In alternative embodiments, a client device will periodically trigger a request for a clock update from a trusted source and then receive the clock update from the trusted source. In yet another embodiment, a client device having protected clock hardware embodied therein may be initialized on a first instance by pushing a clock update to the client device or triggering the client device to request its first clock update and then receive the requested clock update (e.g., when initializing a newly manufactured client device).

At block 215, processing logic updates the protected clock based on the clock update from the trusted source.

At block 220, processing logic maintains the protected clock accurately between the periodic updates from the trusted source regardless of operating state for the client device. For instance, a secure flash, such as the protected flash storage 175 may be used to provide consistency for the computing device 101 in the event the computing device completely loses power.

At block 225, processing logic returns a trusted time stamp upon request.

The above method 200 may be utilized by a software component, application or another platform component, to request a trusted time stamp from the platform and receive the trusted time stamp signed by the platform's cryptographic engine. For instance, with reference again to FIG. 1, a cryptographic engine of a platform may be embodied within a time provider 125 at the operating system or within a firmware time service 165. Secure time stamp capabilities may additionally be extended for use through other platform capabilities, such as secure location functionality, Enterprise Risk Management (ERM) components and functionality, etc., so as to allow the same secure time stamping capabilities by both Host software and firmware components in coherent way.

According to one embodiment, trusted time for a client device is initiated when the client device is provisioned along with the rest of the platform components. At provisioning time, two cryptographic keys are provisioned to the client device. A first of the two cryptographic keys is to validate the external trusted time source such that the client device is able to securely receive, obtain, or retrieve a trusted time stamp from the external trusted time source. The second of the two cryptographic keys is to sign the trusted time from the protected clock hardware of the client device upon request or on an as-needed basis on behalf of the client device, thus providing or generating the trusted time stamp representing the present time of the client device but in a secured and trusted format. According to one embodiment, the first of the two cryptographic keys is a public key/hash which is used to validate the external time source and the second of the two cryptographic keys is a private key or a private signing key which is used to sign the trusted time stamps. According to such an embodiment, both the first and the second of the two cryptographic keys are provisioned to the client device initially. Subsequently, the public key/hash is used to periodically or on demand obtain, update, or symphonize a trusted time from an external trusted source and the second of the two cryptographic keys, the private key, is used on demand to sign the tracked time of the protected clock hardware at the computing device and provide trusted results (e.g., a trusted time stamp) to the requesting entity, such as software executing on the client device.

With the trusted time now signed, the client device is configured with the location and any necessary authentication details for the entity that is going to provide trusted time updates and synchronization services for the client device. For instance, it may be necessary to configure the client device with the credentials required to communicate with a trusted time server. Once provisioned, the platform can then autonomously go and request a trusted time. Once the trusted time is received from the configured trusted time server, the trusted time can be maintained locally by the client device. For instance, the trusted time may be preserved within the local protected flash storage using the given offset provided by the trusted time server. For example, the client device may be configured to go to a time server within an enterprise network, in which case the client device is provided with the firmware the fully qualified domain name of the time server within the enterprise. Alternatively, an external trusted NTP compatible server may be established with the requisite authentication mechanisms and sufficient level of trust for the given implementation, after which the client device so configured will be allowed to authenticate with the trusted NTP compatible server and retrieve the trusted time updates therefrom. Validating a trusted time update will be described in further detail below.

At FIG. 2B, method 201 depicts an alternative embodiment for updating or synchronizing secured time of the client device.

Method 201 begins with processing logic for operating a protected clock at a client device (block 230).

At block 235, processing logic triggers, via a firmware time service of the client device, a request for time update or synchronization.

At block 240, processing logic establishes network connectivity to a time server remote from the client device. For instance, network connectivity may be established to the time server over the public Internet, network connectivity may be established to the time server over a Virtual Private Network (VPN) session over the public Internet, network connectivity may be established to the time server over an enterprise Local Area Network (LAN) for a client device operating within the enterprise's LAN network, or network connectivity may be established to the time server over using Transport Layer Security (TLS) or a Secure Sockets Layer (SSL) session compatible with cryptographic protocols required by the time server when communicating time updates or synchronizations with the remote client device.

According to one embodiment, a firmware time service 165 of the client device 101 establishes network connectivity to the time server through an End-to-End (E2E) security session tunnel between the time server and the client device, in which a network stack 130 of the client device 101 serves as a path-through mechanism with no visibility into the tunnel.

At block 245, processing logic receives the time update or synchronization from the time server. According to one embodiment, the time update or synchronization is received by the firmware time service 165 of the client device 101.

At block 250, processing logic updates the protected clock hardware of the client device. For example, the firmware time service 165 updates the protected clock hardware at element 180 of FIG. 1 in accordance with one embodiment.

At block 255, processing logic records an offset into a protected flash storage of the client device.

According to one embodiment, the time update and synchronization is stored in accordance with Network Time Protocol (NTP), however, it is not necessary that such a protocol or format be utilized to practice the invention. NTP provides Coordinated Universal Time (UTC) including scheduled leap second adjustments. Information regarding time zones is not provided. NTP enables the maintenance, updating and synchronization of time between remote network nodes, such as a client device and remote time server. Notably however, conventional NTP systems do not provide secure time stamps; the format of NTP communications may nevertheless be utilized in accordance with the disclosed embodiments. For example, in one embodiment, an NTP compatible formatted absolute time and offset is transmitted from a trusted time server to the client device 101 as part of receiving the time update or synchronization.

In an alternative embodiment, the client device 101 receives an absolute time and an offset from a trusted time server as part of receiving the time update or synchronization, but neither the absolute time nor the offset is transmitted in an NTP compatible format.

At FIG. 2C, method 202 depicts an alternative embodiment for processing a request for a trusted time stamp in accordance with the disclosed embodiments. Method 202 may be utilized at a client device 101 to protect against as replay or alternation style attack.

Method 202 begins with processing logic at a time server, remote from a client device having protected clock hardware embodied therein, sending a request with its own time stamp and cryptographic hash of that request (block 260). For instance, a trusted time server 150 may send a request which is subjected to a Secure Hash Algorithm (SHA) implementation of a cryptographic hash function by the trusted time server 150.

At block 265, processing logic at the client device returns to the time server, the client device's trusted time and the time stamp received from the time server along with a signed hash of both the client device's trusted time the time stamp received from the time server. For example, a firmware time service of the client device may implement such a function.

At block 270, processing logic at the time server validates the hashes from the client device and further checks that the response is related to the correct request by comparing its own existing time stamp with the one in the client device's response. The client device echoes the time server's time stamp back, and thus, an exact and identical comparison can be made. Such an implementation negates the possibility for a replay attack as any malicious entity attempting to capture and later return the echoed time server's own time stamp, assuming the hashes could be mimicked, would nevertheless be invalidated due to the mismatched return of the time server's time stamp.

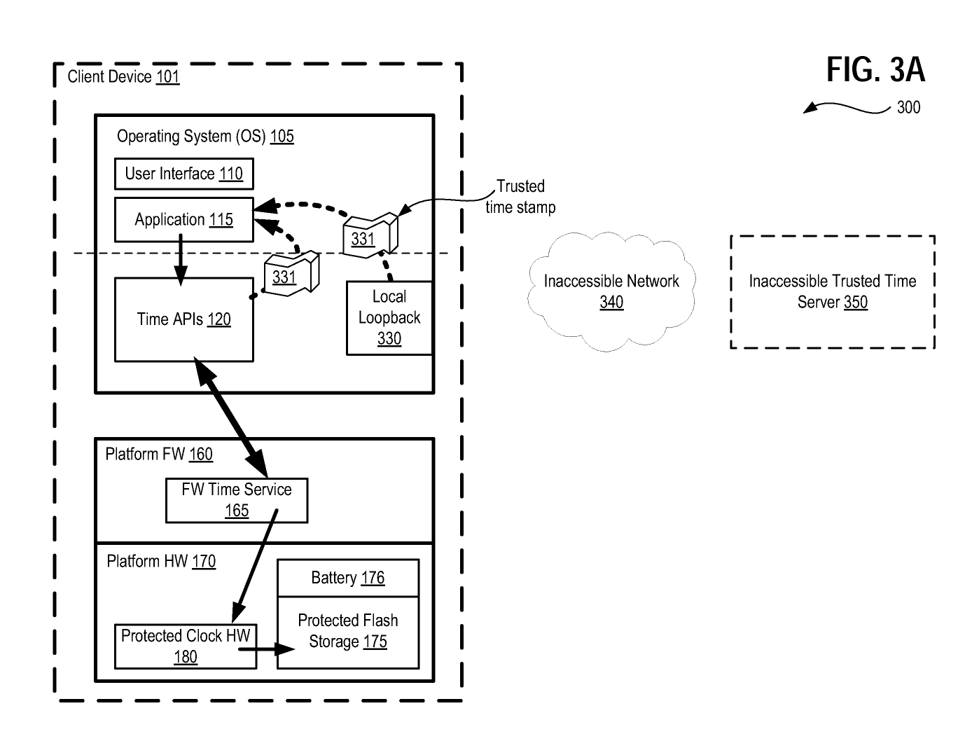

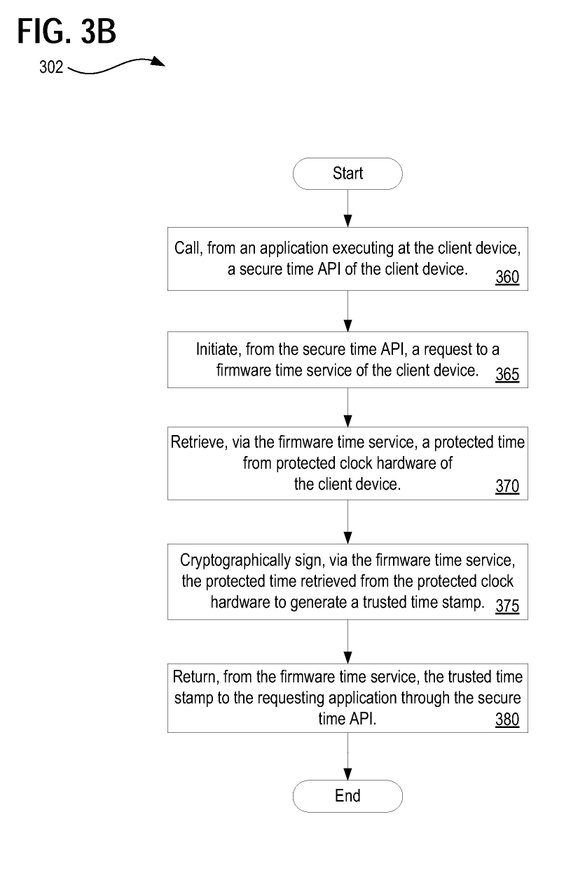

FIG. 3A illustrates an alternative exemplary architecture 300 in accordance with which embodiments may operate. In particular, client device 101 is again depicted, however, no communication may be established with the remote inaccessible trusted time server 350 shown due to the inaccessible network 340 separating the client device 101 from the inaccessible trusted time server 350.

Notwithstanding the lack of network connectivity to any remote entity, the client device 101 may nevertheless provide a trusted time stamp through practice of the disclosed embodiments.

According to one embodiment, an application requests and receives a trusted time stamp 331 through time APIs 120 of the client device. According to an alternative embodiment, an application requests and receives a trusted time stamp 331 through a local loopback 330 of the client device 101.

FIG. 3B is a flow diagram illustrating a method 302 for maintaining trusted time at a client computing device in accordance with described embodiments. Method 302 describes a network agnostic process for requesting and receiving a trusted time stamp 331 at the computing device. In such an embodiment, there is no requirement for network connectivity to any remote entity and thus, the method is unaffected by the presence of an inaccessible network 340 and inaccessible trusted time server 350. The method 302 is further unaffected by the presence of an accessible network as no reference to or reliance upon such a network is made by the client device 101 or its functionality. In such an embodiment, reference to a local loopback 330 is not considered a reference to a network, but rather is considered to be a reference to the client device 101 itself through the local loopback 330, notwithstanding the fact that the local loopback 330 may appear to the system as a network address.

Method 302 begins with processing logic calling, from an application executing at the client device, a secure time API of the client device (block 360).

At block 365, processing logic at the secure time API initiates a request to a firmware time service of the client device.

At block 370, processing logic at the firmware time service retrieves a protected time from protected clock hardware of the client device.

At block 375, processing logic at the firmware time service cryptographically signs the protected time retrieved from the protected clock hardware to generate a trusted time stamp.

At block 380, processing logic at the firmware time service returns the trusted time stamp to the requesting application through the secure time API.

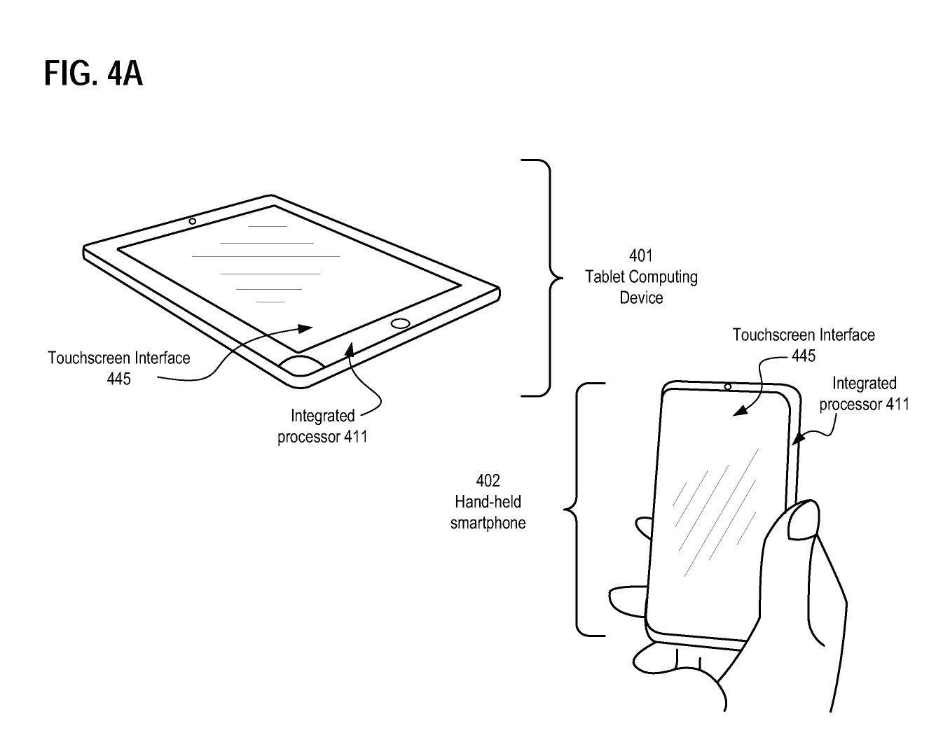

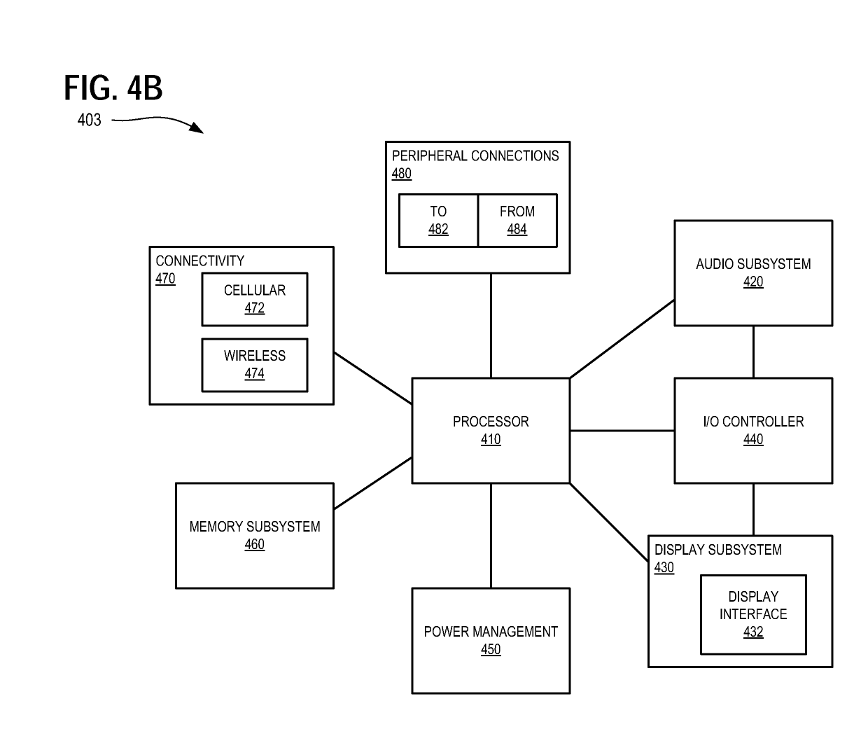

FIG. 4A depicts a tablet computing device 401 and a hand-held smartphone 402 each having a circuitry, components, and functionality integrated therein as described in accordance with the embodiments, such as a compiler and computing devices for maintaining trusted time at a client computing device. As depicted, each of the tablet computing device 401 and the hand-held smartphone 402 include a touchscreen interface 445 and an integrated processor 411 in accordance with disclosed embodiments.

For example, in one embodiment, a client device, such as the exemplary computing platform depicted at element 101 of FIG. 1, may be embodied by a tablet computing device 401 or a hand-held smartphone 402, in which a display unit of the apparatus includes the touchscreen interface 445 for the tablet or smartphone and further in which memory and an integrated circuit operating as an integrated processor 411 are incorporated into the tablet or smartphone. In such an embodiment, the integrated processor 411 includes functionality to implement a secure platform based time server according to the techniques described above.

FIG. 4B is a block diagram 403 of an embodiment of a tablet computing device, a smart phone, or other mobile device in which touchscreen interface connectors are used. Processor 410 performs the primary processing operations. Audio subsystem 420 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 410.

Display subsystem 430 represents hardware (e.g., display devices) and software (e.g., drivers) components that provide a visual and/or tactile display for a user to interact with the tablet computing device or smart phone. Display subsystem 430 includes display interface 432, which includes the particular screen or hardware device used to provide a display to a user. In one embodiment, display subsystem 430 includes a touchscreen device that provides both output and input to a user.

I/I controller 440 represents hardware devices and software components related to interaction with a user. I/O controller 440 can operate to manage hardware that is part of audio subsystem 420 and/or display subsystem 430. Additionally, I/O controller 440 illustrates a connection point for additional devices that connect to the tablet computing device or smart phone through which a user might interact. In one embodiment, I/O controller 440 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 450 that manages battery power usage, charging of the battery, and features related to power saving operation. Memory subsystem 460 includes memory devices for storing information in the tablet computing device or smart phone. Connectivity 470 includes hardware devices (e.g., wireless and/or wired connectors and communication hardware) and software components (e.g., drivers, protocol stacks) to the tablet computing device or smart phone to communicate with external devices. Cellular connectivity 472 may include, for example, wireless carriers such as GSM (global system for mobile communications), CDMA (code division multiple access), TDM (time division multiplexing), or other cellular service standards). Wireless connectivity 474 may include, for example, activity that is not cellular, such as personal area networks (e.g., Bluetooth), local area networks (e.g., WiFi), and/or wide area networks (e.g., WiMax), or other wireless communication.

Peripheral connections 480 include hardware interfaces and connectors, as well as software components (e.g., drivers, protocol stacks) to make peripheral connections as a peripheral device (“to” 482) to other computing devices, as well as have peripheral devices (“from” 484) connected to the tablet computing device or smart phone, including, for example, a “docking” connector to connect with other computing devices. Peripheral connections 480 include common or standards-based connectors, such as a Universal Serial Bus (USB) connector, DisplayPort including MiniDisplayPort (MDP), High Definition Multimedia Interface (HDMI), Firewire, etc.

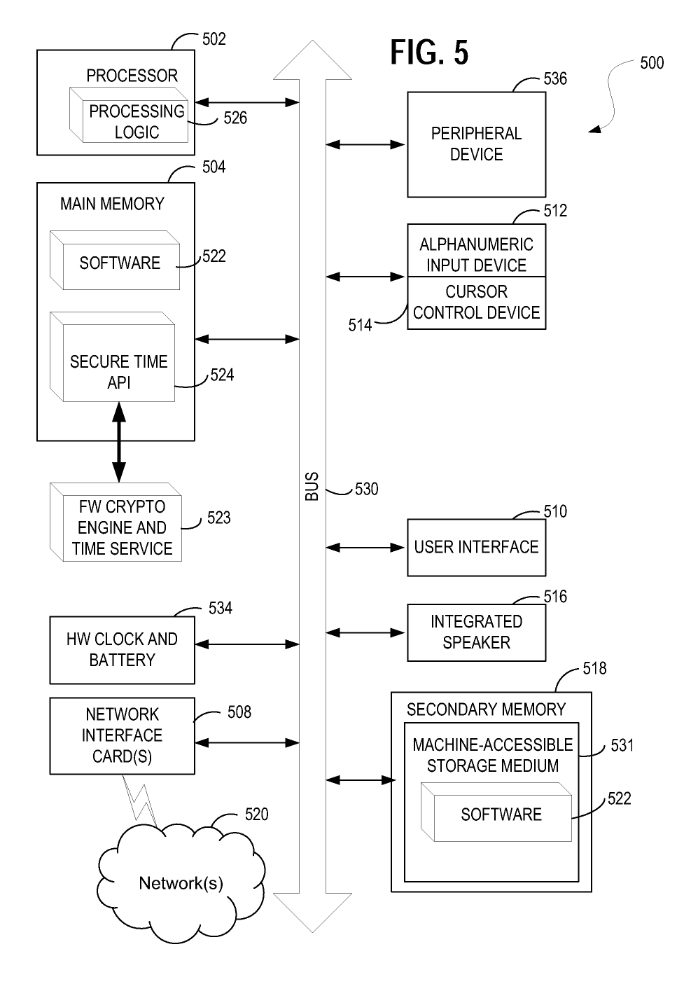

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer-to-peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent data base implementations), which communicate with each other via a bus 530. Main memory 504 includes information and instructions and software program components necessary for performing and executing the functions with respect to the various embodiments of the systems, methods, and entities as described herein including functionality to implement a secure platform based time server according to the techniques described above. The secure time API at element 524 may be stored within main memory 504 and operate in conjunction with firmware cryptographic engine and time service at element 523 accessible via the secure time API 524. Main memory 504 and its sub-element (e.g. 524) are operable in conjunction with processing logic 526 and/or software 522, firmware (e.g., 523), and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality which is discussed herein.

The computer system 500 may further include one or more network interface cards 508 to communicatively interface the computer system 500 with one or more networks 520, such as the Internet or a publicly accessible network. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc.). Hardware clock and battery 534 may be integrated into the exemplary machine 500 consistent with the embodiments previously described.

The secondary memory 518 may include a non-transitory machine-readable storage medium (or more specifically a non-transitory machine-accessible storage medium) 531 on which is stored one or more sets of instructions (e.g., software 522) embodying any one or more of the methodologies or functions described herein. Software 522 may also reside, or alternatively reside within main memory 504, and may further reside completely or at least partially within the processor 502 during execution thereof by the computer system 500, the main memory 504 and the processor 502 also constituting machine-readable storage media. The software 522 may further be transmitted or received over a network 520 via the network interface card 508.

In accordance with the preceding disclosure, the following exemplary embodiments are presented as follows:

According to a first embodiment there is a method having the following operations: executing a computer program within a client device; initiating a call from the computer program to a secure time service of the client device requesting a trusted time stamp; retrieving, via the secure time service of the client device, a protected time from protected clock hardware of the client device; generating, at the secure time service of the client device, the trusted time stamp by signing the protected time retrieved from the protected clock hardware of the client device; and returning the trusted time stamp to the computer program.

According to an embodiment of the method, the secure time service includes an agent executing in firmware of the client device accessible through an Application Programming Interface (API) of the client device.

According to an embodiment of the method, initiating a call from the computer program to a secure time service of the client device requesting a trusted time stamp includes calling a method of the API from the computer program requesting the secure time stamp.

According to an embodiment of the method, executing the computer program within a client device includes one of: executing an operating system at the client device, in which the operating system initiates the call for the trusted time stamp; executing a user interface and a user application at the client device, in which the user application initiates the call for the trusted time stamp; executing logging software at the client device, in which the logging software initiates the call for the trusted time stamp; executing a background service at the client device, in which the background service initiates the call for the trusted time stamp; executing a peripheral driver at the client device, in which the peripheral driver initiates the call for the trusted time stamp; executing a certificate validation program at the client device, in which the certificate validation program initiates the call for the trusted time stamp; executing trialware software having a limited time period of free usage at the client device, in which the trialware software initiates the call for the trusted time stamp; and executing an event logger at the client device, in which the event logger initiates the call for the trusted time stamp.

According to an embodiment of the method, the secure time service of the client device includes: a firmware level agent having two cryptographic keys configured therein, the two cryptographic keys being inaccessible to an operating system of the client device or computer programs executing on the operating system of the client device; in which receiving a time update from an external trusted time source to update the protected time within the protected clock hardware of the client device includes verifying the time update received at the client device using a first of the two cryptographic keys; in which retrieving the protected time from protected clock hardware of the client device includes retrieving the protected time from the protected clock hardware using a second of the two cryptographic keys; and further in which generating the trusted time stamp by signing the protected time includes cryptographically signing the protected time using the second of the two cryptographic keys.

According to an embodiment of the method, the client device includes: the computer program executing at a software layer of the client device via a memory and processor of the client device; the secure time service of the client device residing within platform firmware of the client device; and the protected clock hardware of the client device maintained by a counter embodied within platform hardware of the client device.

According to an embodiment of the method, the platform hardware of the client device further includes protected flash storage to maintain an offset for the counter and a battery to provide power to the protected clock hardware of the client device through varying power states of the client device.

According to an embodiment of the method, initiating a call from the computer program to a secure time service of the client device requesting a trusted time stamp includes referencing a network address corresponding to a local loopback of the client device, in which the local loopback is communicatively interfaced to the secure time service of the client device accessible through an Application Programming Interface (API) of the client device; and in which returning the trusted time stamp to the computer program includes returning the trusted time stamp through the local loopback of the client device via networking protocols.

According to an embodiment of the method, operations further include: initializing the protected clock with the protected time at provisioning of the client device.

According to an embodiment of the method, initializing the protected clock with the protected time includes: operating the protected clock at the client device; receiving a clock update from a trusted source; and updating the protected clock based on the clock update from the protected source.

According to an embodiment of the method, operations further include: iteratively receiving clock updates from the trusted source when the client device is connected via a network to the protected source, in which the protected source is distinct from the client device; and maintaining the protected clock accurately between iteratively receiving the clock updates from the trusted source.

According to an embodiment of the method, the trusted source includes a trusted time server remotely located from the client device, in which the client device communicates with the trusted time server via a network.

According to an embodiment of the method, initializing the protected clock with the protected time further includes configuring the secure time service with one of: a fully qualified domain name of a trusted time server within a enterprise network fire-walled from a public Internet; a network address for a trusted Network Time Protocol (NTP) compatible server having an authentication mechanism and credentials of the client device to authenticate with the trusted NTP compatible server, in which the client device operates within a Local Area Network (LAN) and accesses the trusted NTP compatible server via the public Internet.

According to an embodiment of the method, operations further include: updating the protected clock at the client device with a time update or synchronization from a trusted time server remote from the client device.

According to an embodiment of the method, updating the protected clock at the client device includes: operating the protected clock at the client device; triggering a request for the time update or synchronization via the secure time service of the client device; establishing network connectivity to the trusted time server remote from the client device via a network; receiving the time update or synchronization from the trusted time server; updating the protected clock hardware of the client device with the received time update or synchronization from the trusted time server; and recording an offset into a protected flash storage of the client device.

According to an embodiment of the method, operations further include: participating in a replay attack resilient time validation process with a trusted time server remote from the client device.

According to an embodiment of the method, participating in the replay attack resilient time validation process with the trusted time server includes: receiving at the client device from the trusted time server, a request having embodied therein a time stamp of the trusted time server and a cryptographic hash of the request; returning, from the client device to the trusted time server, the client device's trusted time and the time stamp received from the time server along with a signed hash of both the client device's trusted time the time stamp received from the trusted time server; and in which the trusted time server validates the hashes from the client device and further checks that the response returned from the client device is related to the correct request from the trusted time server by comparing the time server's own existing time stamp with the one returned in the client device's response to the trusted time server.

According to an embodiment of the method, the client device is embodied within one of a tablet computing device or a smartphone.

There is according to another embodiment, one or more non-transitory computer readable storage media having instructions stored thereon that, when executed by a client device, the instructions cause the client device to perform operations including: executing a computer program within the client device; initiating a call from the compute program to a secure time service of the client device requesting a trusted time stamp; retrieving, via the secure time service of the client device, a protected time from protected clock hardware of the client device; generating, at the secure time service of the client device, the trusted time stamp by signing the protected time retrieved from the protected clock hardware of the client device; and returning the trusted time stamp to the computer program.

According to another embodiment of the one or more non-transitory computer readable storage media, the secure time service includes an agent executing in firmware of the client device accessible through an Application Programming Interface (API) of the client device.

According to another embodiment of the one or more non-transitory computer readable storage media, the secure time service of the client device includes: a firmware level agent having two cryptographic keys configured therein, the two cryptographic keys being inaccessible to an operating system of the client device or computer programs executing on the operating system of the client device; in which receiving a time update from an external trusted time source to update the protected time within the protected clock hardware of the client device includes verifying the time update received at the client device using a first of the two cryptographic keys; in which retrieving the protected time from protected clock hardware of the client device includes retrieving the protected time from the protected clock hardware using a second of the two cryptographic keys; and further in which generating the trusted time stamp by signing the protected time includes cryptographically signing the protected time using the second of the two cryptographic keys.

According to another embodiment of the one or more non-transitory computer readable storage media, the client device is embodied within one of a tablet computing device or a smartphone.

There is a client device in accordance with one embodiment, in which the client device includes: a processor and a memory for executing a computer program executing a computer program within the client device; an Application Programming Interface (API) to receive a call requesting a trusted time stamp from the compute program, in which the API interfaces the call to a secure time service of the client device; platform firmware having the secure time service residing therein to retrieve a protected time from protected clock hardware of the client device; platform hardware having the protected clock hardware embodied therein to return the protected time to the secure time service; the secure time service to generate the trusted time stamp by signing the protected time retrieved from the protected clock hardware; and the secure time service to return the trusted time stamp to the computer program.

According to another embodiment of the client device, the platform firmware of the client device further includes a cryptographic engine to sign the protected time retrieved from the protected clock hardware to generate the trusted time stamp.

According to another embodiment of the client device, the protected clock hardware includes tamper resistant non-volatile memory having a local battery backup to maintain state of the protected clock hardware through multiple power state changes of the client device.

According to another embodiment of the client device, the protected clock hardware of the client device includes: a hardware counter; a protected flash storage to maintain an offset for the counter; and a battery to provide power to the protected clock hardware of the client device through varying power states of the client device.

According to another embodiment, the client device further includes: a network interface to communicatively interface the client device with a trusted time server remote from the client device over a network, in which the trusted time server to provide time updates or synchronization to the client device.

According to another embodiment of the client device, the client device is embodied within one of a tablet computing device or a smartphone.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method comprising:
executing a computer program within a client device;
initiating a call from the computer program to a secure time service of the client device requesting a trusted time stamp;
retrieving, via the secure time service of the client device, a protected time from protected clock hardware of the client device;
generating, at the secure time service of the client device, the trusted time stamp by signing the protected time retrieved from the protected clock hardware of the client device; and
returning the trusted time stamp to the computer program.

2. The method of claim 1, wherein the secure time service comprises an agent executing in firmware of the client device accessible through an Application Programming Interface (API) of the client device.

3. The method of claim 2, wherein initiating a call from the computer program to a secure time service of the client device requesting a trusted time stamp comprises calling a method of the API from the computer program requesting the secure time stamp.

4. The method of claim 1, wherein executing the computer program within a client device comprises one of:
executing an operating system at the client device, wherein the operating system initiates the call for the trusted time stamp;
executing a user interface and a user application at the client device, wherein the user application initiates the call for the trusted time stamp;
executing logging software at the client device, wherein the logging software initiates the call for the trusted time stamp;
executing a background service at the client device, wherein the background service initiates the call for the trusted time stamp;
executing a peripheral driver at the client device, wherein the peripheral driver initiates the call for the trusted time stamp;
executing a certificate validation program at the client device, wherein the certificate validation program initiates the call for the trusted time stamp;
executing trialware software having a limited time period of free usage at the client device, wherein the trialware software initiates the call for the trusted time stamp; and
executing an event logger at the client device, wherein the event logger initiates the call for the trusted time stamp.

5. The method of claim 1, wherein the secure time service of the client device comprises:
a firmware level agent having two cryptographic keys configured therein, the two cryptographic keys being inaccessible to an operating system of the client device or computer programs executing on the operating system of the client device;
wherein receiving a time update from an external trusted time source to update the protected time within the protected clock hardware of the client device comprises verifying the time update received at the client device using a first of the two cryptographic keys;
wherein retrieving the protected time from protected clock hardware of the client device comprises retrieving the protected time from the protected clock hardware using a second of the two cryptographic keys; and
wherein generating the trusted time stamp by signing the protected time comprises cryptographically signing the protected time using the second of the two cryptographic keys.

6. The method of claim 1, wherein the client device comprises:
the computer program executing at a software layer of the client device via a memory and processor of the client device;
the secure time service of the client device residing within platform firmware of the client device; and
the protected clock hardware of the client device maintained by a counter embodied within platform hardware of the client device.

7. The method of claim 6, wherein the platform hardware of the client device further comprises protected flash storage to maintain an offset for the counter and a battery to provide power to the protected clock hardware of the client device through varying power states of the client device.

8. The method of claim 1:
wherein initiating a call from the computer program to a secure time service of the client device requesting a trusted time stamp comprises referencing a network address corresponding to a local loopback of the client device, wherein the local loopback is communicatively interfaced to the secure time service of the client device accessible through an Application Programming Interface (API) of the client device; and
wherein returning the trusted time stamp to the computer program comprises returning the trusted time stamp through the local loopback of the client device via networking protocols.

9. The method of claim 1, further comprising:
initializing the protected clock with the protected time at provisioning of the client device.

10. The method of claim 9, wherein initializing the protected clock with the protected time comprises:
operating the protected clock at the client device;
receiving a clock update from a trusted source; and
updating the protected clock based on the clock update from the protected source.

11. The method of claim 10, further comprising
iteratively receiving clock updates from the trusted source when the client device is connected via a network to the protected source, wherein the protected source is distinct from the client device; and
maintaining the protected clock accurately between iteratively receiving the clock updates from the trusted source.

12. The method of claim 10, wherein the trusted source comprises a trusted time server remotely located from the client device, wherein the client device communicates with the trusted time server via a network.

13. The method of claim 10, wherein initializing the protected clock with the protected time further comprises configuring the secure time service with one of:
a fully qualified domain name of a trusted time server within a enterprise network fire-walled from a public Internet;
a network address for a trusted Network Time Protocol (NTP) compatible server having an authentication mechanism and credentials of the client device to authenticate with the trusted NTP compatible server, wherein the client device operates within a Local Area Network (LAN) and accesses the trusted NTP compatible server via the public Internet.

14. The method of claim 1, further comprising:
updating the protected clock at the client device with a time update or synchronization from a trusted time server remote from the client device.

15. The method of claim 14, wherein updating the protected clock at the client device comprises:
operating the protected clock at the client device;
triggering a request for the time update or synchronization via the secure time service of the client device;
establishing network connectivity to the trusted time server remote from the client device via a network;
receiving the time update or synchronization from the trusted time server;
updating the protected clock hardware of the client device with the received time update or synchronization from the trusted time server; and
recording an offset into a protected flash storage of the client device.

16. The method of claim 1, further comprising:
participating in a replay attack resilient time validation process with a trusted time server remote from the client device.

17. The method of claim 16, wherein participating in the replay attack resilient time validation process with the trusted time server comprises:
receiving at the client device from the trusted time server, a request having embodied therein a time stamp of the trusted time server and a cryptographic hash of the request;
returning, from the client device to the trusted time server, the client device's trusted time and the time stamp received from the time server along with a signed hash of both the client device's trusted time the time stamp received from the trusted time server; and
wherein the trusted time server validates the hashes from the client device and further checks that the response returned from the client device is related to the correct request from the trusted time server by comparing the time server's own existing time stamp with the one returned in the client device's response to the trusted time server.

18. The method of claim 1, wherein the client device is embodied within one of a tablet computing device or a smartphone.

19. One or more non-transitory computer readable storage media having instructions stored thereon that, when executed by a client device, the instructions cause the client device to perform operations including:
executing a computer program within the client device;
initiating a call from the computer program to a secure time service of the client device requesting a trusted time stamp;
retrieving, via the secure time service of the client device, a protected time from protected clock hardware of the client device;
generating, at the secure time service of the client device, the trusted time stamp by signing the protected time retrieved from the protected clock hardware of the client device; and
returning the trusted time stamp to the computer program.

20. The one or more non-transitory computer readable storage media of claim 19, wherein the secure time service comprises an agent executing in firmware of the client device accessible through an Application Programming Interface (API) of the client device.

21. The one or more non-transitory computer readable storage media of claim 19, wherein the secure time service of the client device comprises:
a firmware level agent having two cryptographic keys configured therein, the two cryptographic keys being inaccessible to an operating system of the client device or computer programs executing on the operating system of the client device;
wherein receiving a time update from an external trusted time source to update the protected time within the protected clock hardware of the client device comprises verifying the time update received at the client device using a first of the two cryptographic keys;
wherein retrieving the protected time from protected clock hardware of the client device comprises retrieving the protected time from the protected clock hardware using a second of the two cryptographic keys; and
wherein generating the trusted time stamp by signing the protected time comprises cryptographically signing the protected time using the second of the two cryptographic keys.

22. The one or more non-transitory computer readable storage media of claim 21, wherein the client device is embodied within one of a tablet computing device or a smartphone.

23. A client device comprising:
a processor and a memory for executing a computer program executing a computer program within the client device;
an Application Programming Interface (API) to receive a call requesting a trusted time stamp from the computer program, wherein the API interfaces the call to a secure time service of the client device;
platform firmware having the secure time service residing therein to retrieve a protected time from protected clock hardware of the client device;
platform hardware having the protected clock hardware embodied therein to return the protected time to the secure time service;
the secure time service to generate the trusted time stamp by signing the protected time retrieved from the protected clock hardware; and
the secure time service to return the trusted time stamp to the computer program.

24. The client device of claim 23, wherein the platform firmware of the client device further comprises a cryptographic engine to sign the protected time retrieved from the protected clock hardware to generate the trusted time stamp.

25. The client device of claim 23, wherein the protected clock hardware comprises tamper resistant non-volatile memory having a local battery backup to maintain state of the protected clock hardware through multiple power state changes of the client device.

26. The client device of claim 23, wherein the protected clock hardware of the client device comprises:
a hardware counter;
a protected flash storage to maintain an offset for the counter; and
a battery to provide power to the protected clock hardware of the client device through varying power states of the client device.

27. The client device of claim 23, further comprising:
a network interface to communicatively interface the client device with a trusted time server remote from the client device over a network, wherein the trusted time server to provide time updates or synchronization to the client device.

28. The client device of claim 23, wherein the client device is embodied within one of a tablet computing device or a smartphone.
